(19) United States
(12) Patent Application Publication
(10) Pub. No.: US 2014/0375167 A1
(43) Pub. Date: Dec. 25, 2014

(54) METHODS FOR PRODUCING EVEN WALL DOWN-HOLE POWER SECTIONS

(71) Applicant: Weatherford/Lamb, Inc., Houston, TX (US)

(72) Inventors: David W. TEALE, Spring, TX (US); Robert P. BADRAK, Sugar Land, TX (US)

(21) Appl. No.: 14/470,171

(22) Filed: Aug. 27, 2014

Related U.S. Application Data
(62) Division of application No. 12/501,560, filed on Jul. 13, 2009, now abandoned.
Application No. 12/501,560 is a division of application No. 11/181,247, filed on Jul. 14, 2005, now abandoned.

(51) Int. Cl. H02K 15/02; B22D 13/00; B22D 13/10; H02K 1/22; H02K 1/12

(52) U.S. Cl. CPC H02K 15/02; H02K 1/22; H02K 1/12; B22D 13/101; B22D 13/00
USPC 310/254.1; 310/261.1; 29/527.6; 164/114; 164/61; 164/66.1; 164/492; 164/493; 164/495; 164/69.1; 164/286

(57) ABSTRACT

Embodiments of the present invention provide methods for manufacturing an even-wall rotor or stator that do not suffer from drawbacks of the prior art. Even-wall rotors or stators produced according to those methods are also provided. In one embodiment, a method for manufacturing a rotor or stator for use in a mud motor is provided. The method includes providing a vacuum chamber; providing a metal electrode at least partially disposed in the vacuum chamber; providing a mold disposed in the vacuum chamber; and melting a portion of the electrode with a direct current arc, the molten metal flowing into the mold ring.

### BACKGROUND OF THE INVENTION

1. Field of the Invention

Embodiments of the present invention generally relate to methods for producing even wall down-hole power sections and power sections produced according to those methods.

2. Description of the Related Art

In drilling a borehole in the earth, such as for the recovery of oil, it is conventional practice to connect a drill bit on the lower end of an assembly of drill pipe sections that are connected end-to-end so as to form a “drill string”. The drill string is rotated and advanced downward, causing the drill bit to cut through the underground rock formation. A pump on the surface typically takes drilling fluid (also known as drilling mud) from a mud pit and forces it down through a passage in the center of the drill string. The drilling fluid then exits the drill bit, in the process cooling the face of the drill bit. The drilling mud returns to the surface by an area located between the borehole and the drill string, carrying with it shavings and bits of rock from downhole.

A conventional motor is typically located on the surface to rotate the drill string and thus the drill bit. Often, a drilling motor that rotates the drill bit may also be placed as part of the drill string a short distance above the drill bit. This allows directional drilling downhole, and can simplify deep drilling. One such motor is called a “Moineau motor” and uses the pressure exerted on the drilling fluid by the surface pump as a source of energy to rotate the drill bit. FIG. 1A is a sectional view of a prior art Moineau motor 100. Motor housing 110 contains an elastomeric rubber stator 120 with multiple helical lobes 125. The stator 120 of FIG. 1A has 5 lobes, although a stator for a Moineau motor with as few as two lobes is possible. Inside the stator 120 is a rotor 140, the rotor 140 by definition having one lobe fewer than does the stator 120. The rotor 140 and stator 120 interengage at the helical lobes to form a plurality of sealing surfaces 149. Sealed chambers 147 between the rotor and stator are also formed.

In operation, drilling fluid is pumped in the chambers 147 formed between the rotor 140 and the stator 120, and causes the rotor to nutate or precess within the stator as a planetary gear would nutate within an internal ring gear. The centerline of the rotor 140 travels in a circular path around the centerline of the stator 120. The gearing action of the stator lobes 125 causes the rotor 140 to rotate as it nutates.

One drawback in such prior art motors is the stress and heat generated by the movement of the rotor 140 within the stator 120. There are several mechanisms by which heat is generated. The first is the compression of the stator rubber by the rotor, known as interference. Radial interference is necessary to seal the chambers to prevent leakage and under typical conditions may be on the order of 0.005″ to 0.030″. The sliding or rubbing movement of the rotor combined with the forces of interference generates friction.

In addition, with each cycle of compression and release of the rubber, heat is generated due to internal viscous friction among the rubber molecules. This phenomenon is known as hysteresis. Cyclic deformation of the rubber occurs due to three effects: interference, centrifugal force, and reactive forces from torque generation. The centrifugal force results from the mass of the rotor moving in the nutational path previously described. Reactive forces from torque generation are similar to those found in gears that are transmitting torque. Additional heat input may also be present from the high temperatures downhole.

Because elastomers are poor conductors of heat, the heat from these various sources builds up in the thick sections 130a-e of the stator lobes. In these areas the temperature rises higher than the temperature of the circulating fluid or the formation. This increased temperature causes rapid degradation of the elastomer. Also, the elevated temperature changes the mechanical properties of the rubber, weakening the stator lobe as a structural member and leading to cracking and tearing of sections 130a-e, as well as portions 145a-e of the rubber at the lobe crests.

This design can also produce uneven rubber strain between the major and minor diameters of the power section. The flexing of the lobes 125 also limits the pressure capability of each stage of the power section by allowing more fluid slippage from one stage to the subsequent stages below.

These forms of rubber degeneration are major drawbacks because when a downhole motor fails, not only must the motor be replaced, but the entire drillstring must be “tripped” or drawn from the borehole, section by section, and then re-inserted with a new motor. Because the operator of a drilling operation is often paying daily rental fees for his equipment, this lost time can be very expensive, especially after the substantial cost of an additional motor.

Advances in manufacturing techniques have led to the introduction of even wall power section motors 150 utilizing thin tubular structures as shown in FIG. 1B. Manufacturing techniques have been developed to produce tubular stator 160 and rotor 140 members that allow manufacturers to bond a thin elastomer material layer 170 on one of these surfaces (layer 170 bonded on stator 160 as shown). These units 150 provide more power output than the traditional designs above due to the more rigid structure and the ability to transfer heat away from the insulative material 170 to the external housing 160. With improved heat transfer and a more rigid structure, the new even wall designs operate more efficiently and can tolerate higher environmental extremes. Although the outer surface of the stator 160 is shown as round in shape, the shape of outer surface may also resemble the shape of the inner surface of the stator. Further, the rotor 140 may be hollow.

Several manufacturing techniques have been developed to produce these tubular members. Hydro forming has been used to produce rotor and stator geometry. This process involves forming a tube into a specific geometry by collapsing the tube onto an inner mandrel of predefined shape using external pressure. The mandrel is extracted and reused after forming. Explosive forming is done utilizing the same process as above with one exception. The external forming pressure is produced by detonating an explosive charge.

Roller forming (Extruding) utilizes rollers and a series of rams to gradually form and shape the tube onto an inner mandrel. Another variation involves a series of consecutive dies and rollers to gradually reduce the tube to final shape. These two processes require precise control of the tube and rollers to create accurate geometry. Once formed, the inner mandrel is extracted and reused as above. Pilger forming is a process where the tube is formed using hydraulic presses that beat or push the material into shape over a preformed mandrel. Investment casting has also been used to create short stator sections. These sections are aligned and joined together to form the complete stator component.

Forming operations require materials that can tolerate a large amount of deformation or cold work to produce the final geometry. Materials are usually low carbon or low strength alloys that are initially in the annealed condition. The part/material gains its final strength through cold work to final shape. The nature of this process excludes the use of high strength materials and limits the use of some non-magnetic materials. Formed parts have a non uniform stress distribution that is geometry-dependent based on varying degrees of cold work as mentioned above. This compromises overall part strength and affects secondary manufacturing operations such as welded end connections, or surface coating integrity.

The length of a formed part is determined by its support equipment, i.e. pressure vessels, fixtures, molds, etc. A large capital investment must be made to produce each unique part. Forming operations are also limited by market driven tubing sizes. Designs, fixtures, etc. must be designed around existing tube stock. The inner mandrel used during forming operations must be extracted from the finished part. This requires additional manufacturing steps that can cause damage to the finished part.

Therefore, there exists a need in the art for a method for manufacturing an even-wall rotor or stator that is economical and produces a rotor or stator that is durable and reliable in operation.

### SUMMARY OF THE INVENTION

Embodiments of the present invention provide methods for manufacturing an even-wall rotor or stator that do not suffer from drawbacks of the prior art. Even-wall rotors or stators produced according to those methods are also provided.

In one embodiment, a method for manufacturing a rotor or stator for use in a mud motor is provided. The method includes providing a vacuum chamber; providing a metal electrode at least partially disposed in the vacuum chamber; providing a mold disposed in the vacuum chamber; and melting a portion of the electrode with a direct current arc, the molten metal flowing into the mold ring.

In one aspect of the embodiment, the method further includes rotating the mold. In another aspect of the embodiment, the mold includes inner and outer members and the molten metal pours into a space between the inner and outer members. In another aspect of the embodiment, the mold has a non-circular profile formed on an inner or outer surface thereof. In another aspect of the embodiment, the mold has a substantially hypocycloid profile formed on an inner or outer surface thereof.

In another embodiment, a method for manufacturing a rotor or stator for use in a mud motor is provided. The method includes providing a robot having a welding gun; depositing a layer of metal using the welding gun; moving either one of the welding gun or the layer away from the other; repeating the depositing and moving step until the rotor or stator is formed.

In one aspect of the embodiment, the layer is deposited onto a base and the method further includes rotating the base. In another aspect of the embodiment, the layer has a non-circular shape. In another aspect of the embodiment, the layer has a circular shape. In another aspect of the embodiment, the layer has a substantially hypocycloid shape. In another aspect of the embodiment, the method is performed in a chamber flooded with an inert or reactive shielding gas. In another aspect of the embodiment, the method is performed in a vacuum chamber.

In another aspect of the embodiment, the layer of metal is deposited by plasma-arc welding. In another aspect of the embodiment, the layer of metal is deposited by a step for pinch arc welding. In another aspect of the embodiment, the layer of metal is deposited by gas tungsten-arc welding. In another aspect of the embodiment, the layer of metal is deposited by flux-cored arc welding. In another aspect of the embodiment, the layer of metal is deposited by submerged arc welding.

In another embodiment, a method for manufacturing a rotor for use in a mud motor is provided. The method includes rotating a mold having a substantially helical-hypocycloid profile formed on an inner surface thereof; and pouring molten metal into the mold, wherein centrifugal force caused by the rotation of the mold will press the molten metal under sufficient pressure so that the molten metal will substantially evenly fill the profiled inner surface.

In another aspect of the embodiment, the mold is in a pressure chamber. In another aspect of the embodiment, a longitudinal centerline of the mold is substantially horizontal.

In another embodiment, a method for manufacturing a rotor or stator for use in a mud motor is provided. The method includes providing a means for manufacturing the rotor or stator; and a step for manufacturing the rotor or stator, thereby producing the rotor or stator having a substantially helical-hypocycloid shape.

In another embodiment, a rotor or stator made according to the method of the first embodiment and/or aspects thereof is provided. In another embodiment, a rotor or stator made according to the method of the second embodiment and/or aspects thereof is provided. In another embodiment, a rotor made according to the method of the third embodiment and/or aspects thereof is provided.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A is a sectional view of a prior art Moineau motor. FIG. 1B is a sectional view of a prior art even wall power section motor.

FIG. 2A is a simplified schematic of a prior art vacuum arc remelting (VAR) process. FIG. 2B is a sectional-isometric view of either a rotor or stator being formed using a VAR process, according to one embodiment of the present invention.

FIG. 3A is an illustration of a typical robot welder 300 as may be used in an alternative embodiment of the present invention. FIG. 3B(1) is a side view of two workpieces prepared to be joined by welding. FIG. 3B(2) is a sectional view of the GMAW gun with a pinch arc power supply in use. FIG. 3C is a sectional view of the PAW gun in use. FIG. 3D is a sectional view of the GTAW gun in use. FIG. 3E is a sectional view of the SMAW gun in use. FIG. 3F is a sectional view of the SAW gun in use. FIG. 3G is an illustration showing a rotor or stator being formed according to an alternative embodiment of the present invention.

FIG. 4 is an isometric view of a finished even wall rotor or stator made using either the VAR or weld casting processes described with reference to FIGS. 2 and 3, respectively.

FIG. 5 is a longitudinal sectional view of a centrifugal casting (CC) apparatus employing a CC process.

### DETAILED DESCRIPTION

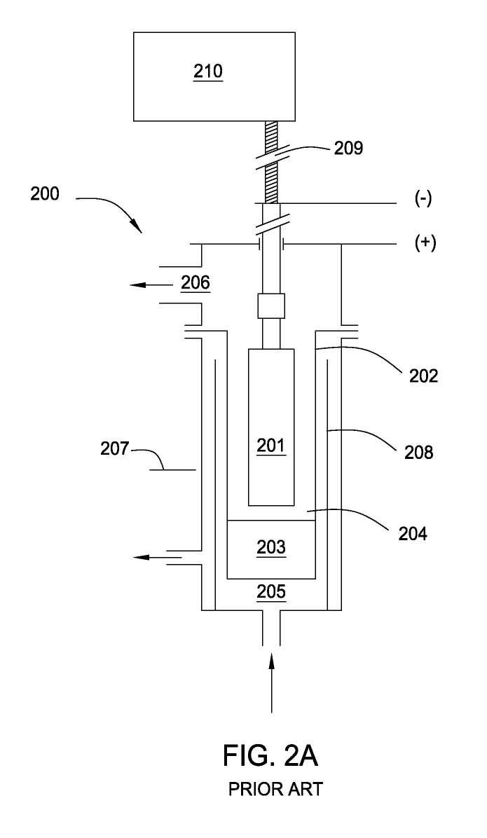

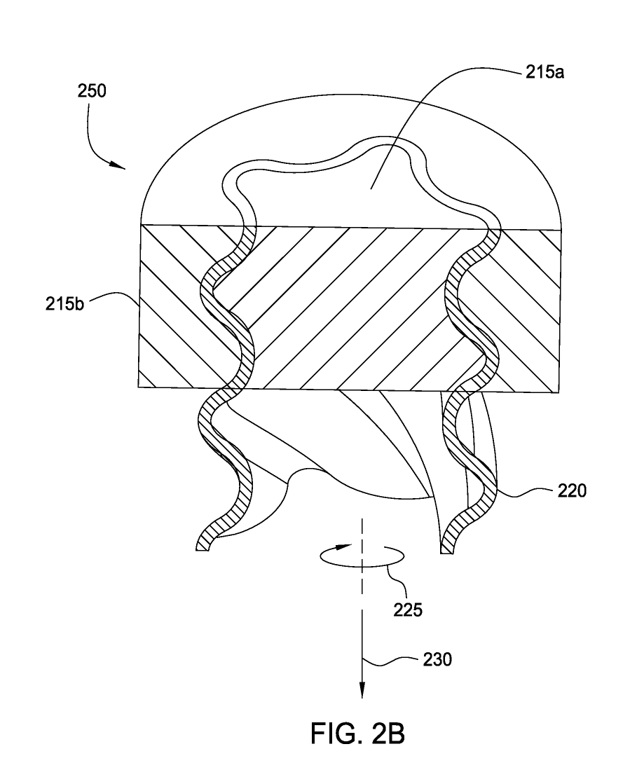

A simplified schematic of a vacuum arc remelting (VAR) process 200 is shown in FIG. 2A. A cylindrically shaped, alloy electrode 201 is loaded into a liquid-cooled, copper crucible or mold 202 of a VAR furnace, the furnace is evacuated, and a direct current (dc) electrical arc is struck between the electrode (cathode) and some start material (e.g., metal chips) at the bottom of the crucible (anode) 202. Alternatively, the electrode 201 may be continuously fed into the mold 202 and the mold may be made from graphite or another conductive material. Preferably, the electrode 201 is made from a metal, such as steel. The arc heats both the start material and the electrode tip, eventually melting both. As the electrode tip is melted away, molten metal drips off, forming a part 203 beneath while the electrode 201 is consumed. Because the crucible diameter is larger than the electrode diameter, the electrode must be translated downwards toward the anode pool to keep the mean distance between the electrode tip and pool surface constant; this mean distance is called the electrode gap 204.

As the cooling water 205 extracts heat from the crucible wall, the molten metal next to the wall solidifies. At some distance below the molten pool surface, the alloy becomes completely solidified, yielding a fully dense part 203. After a sufficient period of time has elapsed, a steady-state situation evolves consisting of a “bowl” of molten material situated on top of a fully solidified part base. As more material solidifies, the part grows. The other significant parts of a typical VAR furnace shown in FIG. 2A include vacuum port 206, furnace body 207, cooling water guide 208, ram drive screw 209, and ram drive motor assembly 210.

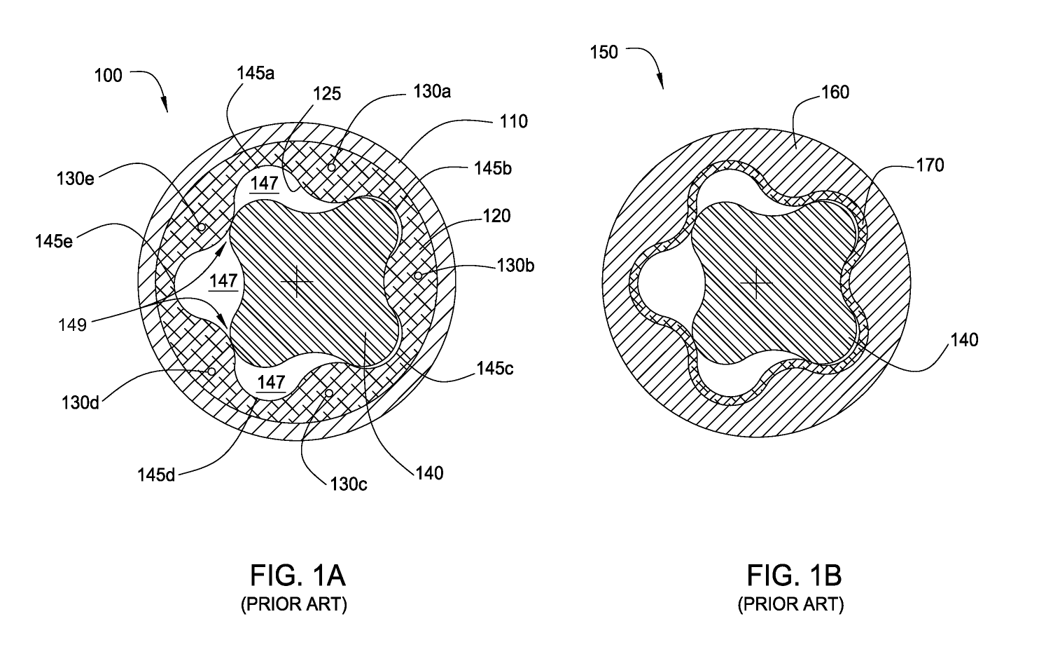

FIG. 2B is a sectional-isometric view of either a rotor or stator 220 being formed using a VAR process 250, according to one embodiment of the present invention. The VAR process 250 can be used to produce the even wall power section shapes as continuous cast products. A tubular mold is composed of inner 215a and outer 215b members. A substantially hypocycloid profile is formed on an inner surface of the outer mold member 215b and on an outer surface of the inner mold member 215a. Alternatively, only the outer mold member 215b is used to form a solid rotor, the inner surface of the outer mold member may simply be round to make the stator 160 shown in FIG. 1B, and/or various profiles may be used to form any desired shape, such as other non-circular shapes.

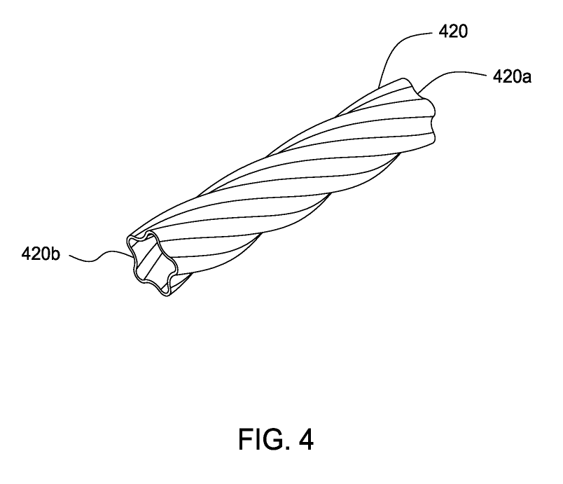

The mold members 215a,b are rotated 225 during the melting process to produce helical-hypocycloid shapes for either rotors or stators 220. As the mold members 215a,b rotate, a solidified portion (see FIG. 4) of the rotor or stator 220 feeds out 230 of the mold rings, thereby resulting in a continuous casting process. Coordinating the material deposition rate with the rotational speed of the mold, any pitch (lead) can be produced with high accuracy mimicking a conventional machining process.

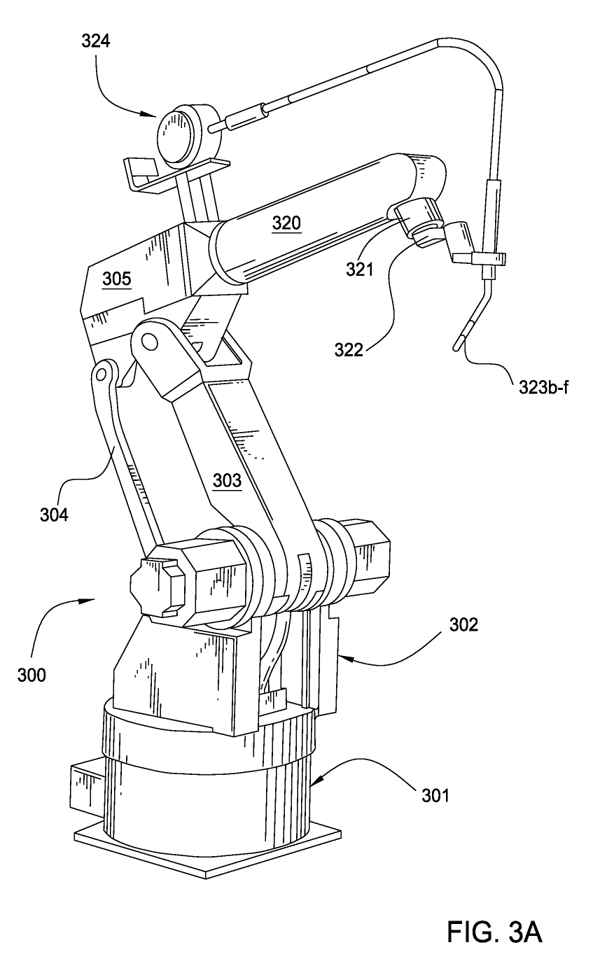

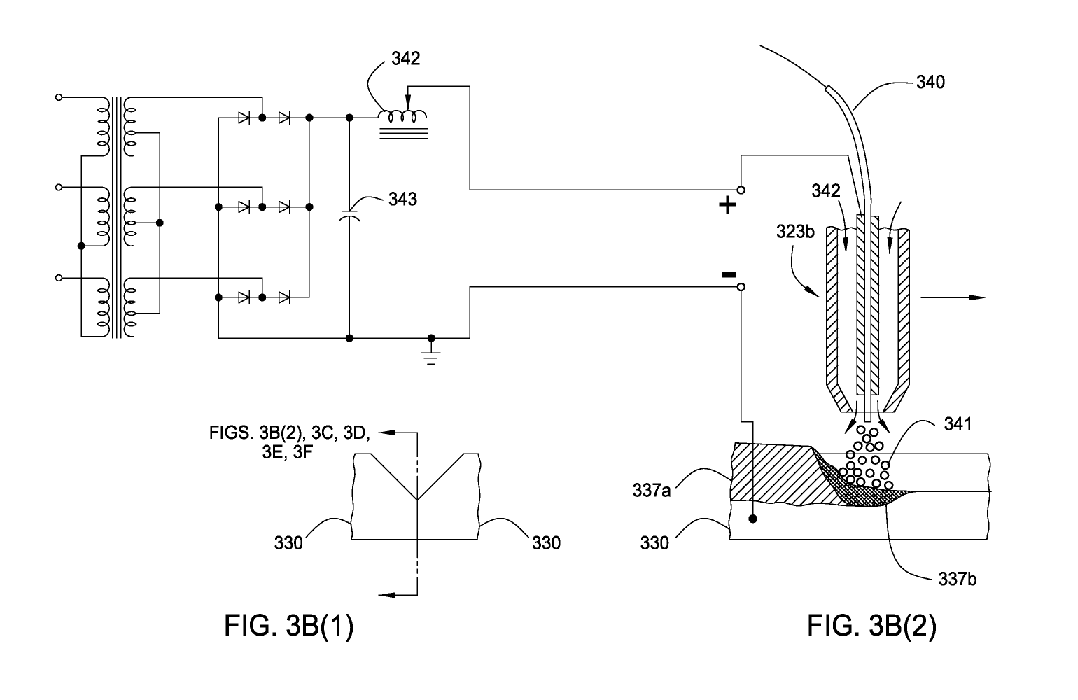

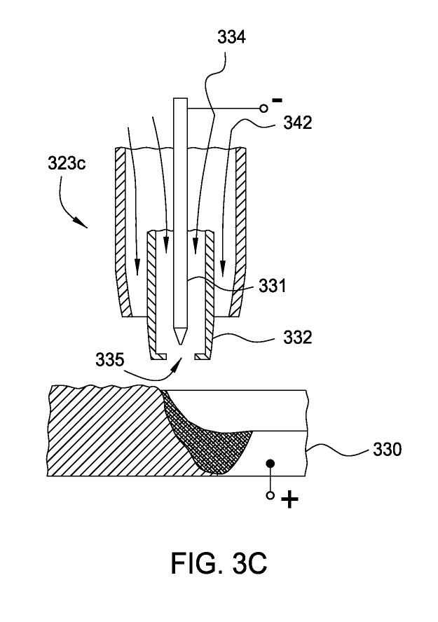

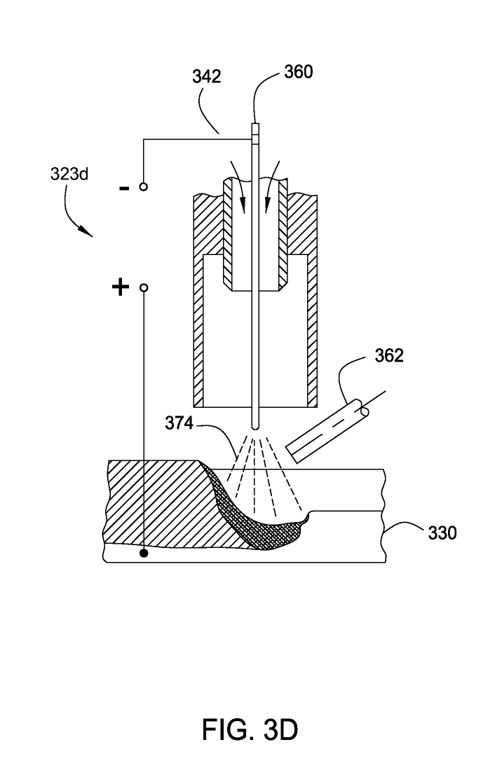

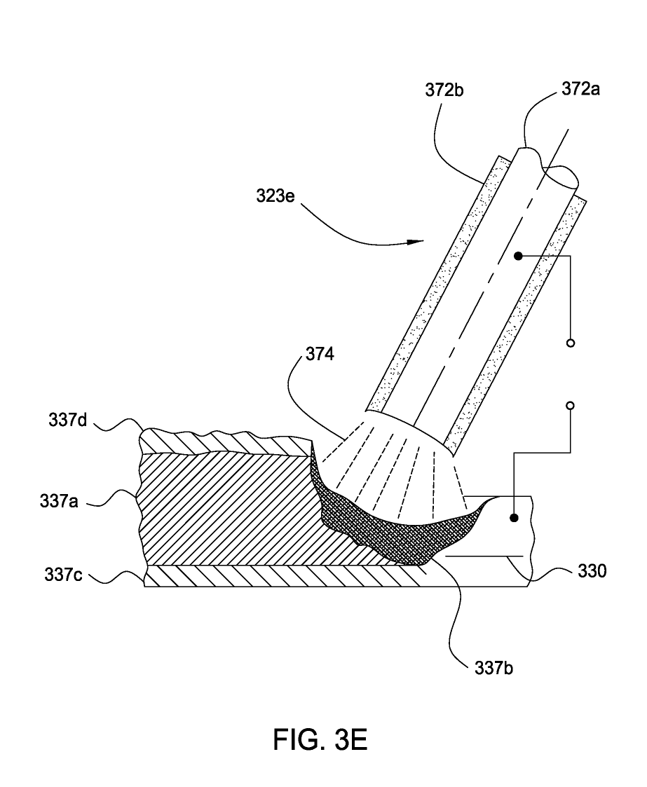

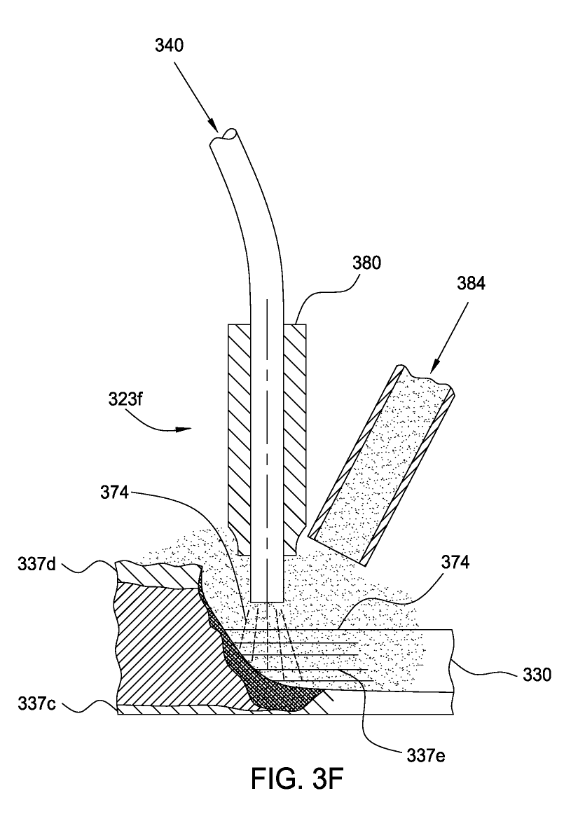

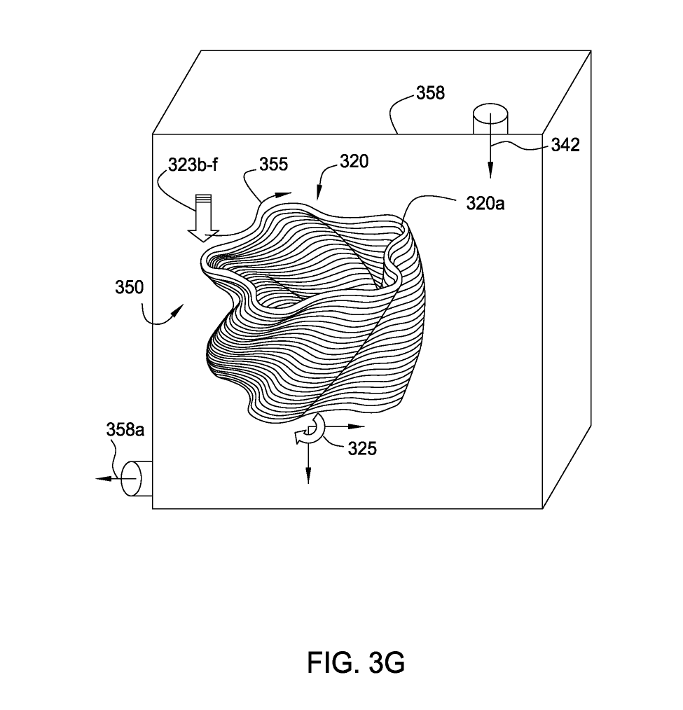

FIG. 3A is an illustration of a typical robot welder 300 as may be used in an alternative embodiment of the present invention. As used herein, the term “robot” includes any automated device. Robot welder 300 may be, for example, a Panasonic Industrial Robot Pana Robo Model AW-010A, manufactured by Matsushita Industrial Equipment Co., Ltd., Osaka, Japan. This particular model is specifically adapted for use in automatic welding operations. Alternatively, a simpler welding robot or arm, i.e. a two or three axis arm, may be used. Robot 300 has a base 301 and a turret 302. The turret 302 is rotatably connected to the base 301. A front arm 303 is rotatably connected to the turret 302. A rear arm 304 is also connected to the turret 302. The front arm 303 and the rear arm 304 are connected to the upper arm 305. The front arm 303 and the rear arm 304 are independent so the rear arm 304 can be used to adjust the angle of the upper arm 305 after the front arm 303 has positioned the upper arm 305.

The upper arm 305 is rotatably connected to a wrist assembly 320. The wrist assembly 320 can be extended or retracted. Further, the wrist assembly 320 is rotatably connected to a first member 321. The first member 321 is rotatably connected to a second member 322. Also, the second member 322 can be extended from or withdrawn to the first member. The second member 322 holds a gas metal-arc welding (GMAW) gun 323b, which is fed by a wire feeder 324. Alternatively, the gun may be a plasma-arc welding (PAW) gun 323c, in which case the wire feeder 324 is not necessary; a gas tungsten-arc welding (GTAW) gun 323d, in which case the wire feeder 324 may be replaced by a filler rod feeder (not shown); a shielded metal arc-welding (SMAW) gun 323e (or a flux-cored arc welding (FCAW) gun (not shown)); or a submerged arc welding (SAW) gun 323f, in which case the wire feeder 324 may be replaced by flux feeder from a hopper. Each robot welder 300 may also include a microprocessor and a memory for storing a job (not shown).

FIG. 3B(1) is a side view of two workpieces prepared to be joined by welding. FIG. 3B(2) is a sectional view of the GMAW gun 323b with a pinch arc power supply in use. A consumable metal electrode 340, fed through the welding gun 323b, is shielded by an inert gas 342. No slag is formed on the solidified weld 337a and several layers can be built up with little or no intermediate cleaning. Examples of suitable inert gasses 342 are argon, helium, a mixture of argon and helium, a mixture of argon and carbon dioxide, carbon dioxide, and carbon dioxide with small amounts of oxygen.

One type of a GMAW process is known as pinch arc or Rapid Arc GMAW. (Rapid Arc was a trademark of Zues Corp., now believed to be out of business. RapidArc is a trademark of Lincoln Electric Co. Note, however, the two processes may not be the same.) Such a pinch arc welder is made under one or more of the following U.S. patents, incorporated herein by reference: U.S. Pat. Nos. 2,800,571, 3,136,884; 3,211,953; 3,211,990; 3,268,842; 3,316,381; 3,489,973; and 4,857,693.

These patents and the website disclose methods and apparatus for pinch arc welding wherein in general context the length of weld wire 340 is provided for deposition 341 in molten form 337b on the workpiece 330 by the steps of electronically coupling a capacitance 343 between the workpiece 330 and the length of weld wire 340, inductively 342 charging the capacitance 343 when the end of the length of weld wire 340 is out of electrical communication with the workpiece 330, discharging the capacitance 343 through the weld wire 340 to establish an arc between the end of the length of weld wire 340 and the workpiece 330 by bringing the end of the length of weld wire 340 into electrical communication with the workpiece 330, whereby the weld wire 340 end is deposited 341 as molten weld metal 337b onto the workpiece 330 while pinching off the end from the rest of the weld wire 340, and continuously feeding weld wire 340 into the arc while shielding the arc from surrounding air.

FIG. 3C is a sectional view of the PAW gun 323c in use. Gas 334 is injected through a constriction nozzle 332 and out an orifice 335. In the space between a tip of a tungsten electrode 331 and the workpiece 330, high temperature strips off electrons from the gas atoms; thus, some of the gas 334 becomes ionized. The mixture of ions and electrons is known as plasma. The plasma becomes hotter by resistance heating from the current passing through it. Since the arc is constrained by an orifice 335, the heat intensity and, thus, the proportion of ionized gas increase and a plasma arc is created. This provides an intense source of heat and ensures greater arc stability. Since workpiece 330 is connected to a positive terminal, electrons flow to the workpiece and the method is known as plasma-transferred arc welding (PTAW).

FIG. 3D is a sectional view of the GTAW (also known as tungsten inert gas (TIG)) gun 323d in use. The arc is maintained between the workpiece 330 and a tungsten electrode 360 protected by the inert gas 342. A filler 362 may or may not be used. To strike an arc 374, electron emission and ionization of the gas 342 are initiated by withdrawing the electrode 360 from the work surface in a controlled manner, or with the aid of an initiating arc. High-frequency current superimposed on the alternating or direct welding current helps to start the arc and also stabilizes it. The weld zone is visible, and there is no weld spatter or slag formation, but electron particles may enter the weld.

FIG. 3E is a sectional view of the SMAW gun 323e in use. The arc 374 is struck between the filler wire or rod (consumable electrode) 372a and the workpieces 330 to be joined. The current may be either ac or dc. In the latter case, the electrode 372a may be negative (dc, electrode negative, DCEN or straight polarity) or positive (DCEP or reverse polarity). The coating 372b fulfills several functions: combustion and decomposition under the heat of the arc 374 creates a protective atmosphere; melting of the coating 372b provides a molten slag 337d cover on the weld 337a,b; the sodium or potassium content of the coating 372b readily ionizes to stabilize the arc 374. Also, alloying elements may be introduced from the coating 372b. During welding, the coating melts into the slag 337d which must be removed if more than one pass is required to build up the full weld thickness. Since the coating 372b is brittle, a variant called flux-cored arc welding (FCAW) is used for automated processes. In FCAW, the coating 372b is placed inside the electrode 372a (called flux instead of coating) so that the electrode 372a may be wire fed. Sometimes additional shielding is provided with a gas, and then the process resembles GMAW. A heat affected zone (HAZ) 337c of the workpiece 330 is also shown.

FIG. 3F is a sectional view of the SAW gun 323f in use. The consumable electrode is now the bare filler wire 340 fed through a contact tube 380. The weld zone is protected by a granular, fusible flux 384 supplied independently from a hopper (not shown) in a thick layer 337e that covers the arc 374. The flux shields the arc 374, allows high currents and great penetration depth, acts as a deoxidizer and scavenger, and may contain powder-metal alloying elements. Tandem electrodes can be used to deposit large amounts of filler material.

FIG. 3G is an isometric view of an even-wall rotor or stator 320 being formed using a weld casting process 350. Utilizing the robot welder 300 and any of the GMAW gun 323b with a pinch arc power supply, the PAW gun 323c (connected for a PTAW process), the GTAW gun 323d, the SMAW (or FCAW) gun 323e; or the SAW gun 323f, a structure, such as the even-wall rotor or stator 320, can be weld formed by following a substantially hypocycloid path 355 as the weld gun 323b-f deposits weld metal in a layer by layer fashion. After each layer 320a is deposited, the created structure 320 is rotated 325 for the next layer so that the helical-hypocycloid shape (see FIG. 4) will be formed and either one of the weld gun 323b-f or the part 320 is moved away from the other so that the next layer may be deposited. The welding gun 323b-f continues following the path 355 and applying material until the part 320 is complete. Alternatively, the weld casting process 350 may be used to form layers of any desired shape, such as circular and other non-circular shapes.

This process capitalizes on the rapid solidification of the weld material and the low energy imparted into the part 320. Without these low temperature processes, the formation of a stable structure would be difficult. Geometric tolerances and material microstructure can be held within tight tolerances with this process. Part surfaces may require secondary machining operations to achieve a smooth surface finish.

Preferably, to guarantee proper metallurgy, this process is done in an environment that provides adequate shielding from reactive elements in the atmosphere. Preferably, each part 320 is produced within a chamber or area 358 flooded with the inert or reactive shielding gas 342 as opposed to just shielding the weld by injecting gas through the weld guns 323b-f. A reactive gas constituent has the advantage of reducing surface oxides that may be present. A vacuum chamber 358 and 358a may also be used to provide this protection. Less preferably, the inert or reactive shielding gas 342 may simply be injected through the welding guns 323b-f, however, this may not provide the one hundred percent shielding potential necessary for certified metallurgy.

FIG. 4 is an isometric view of a finished even wall rotor or stator 420 made using either the VAR or weld casting processes described with reference to FIGS. 2 and 3, respectively. Ends 420a,b may receive couplings (not shown) so that the rotor or stator 420 may be disposed in a drill string (not shown). Alternatively, the ends 420a,b may be formed with other useful features.

Using Weld Casting or the VAR process to produce tubular shapes has many advantages over existing manufacturing techniques. The Weld Cast or VAR process allows the use of a wider range of base materials and higher strength alloys including the majority of non-magnetic materials. Weld Cast or VAR produced parts have uniform stress distribution. The Weld Cast or VAR process can produce parts of varying length with theoretically no length limitation since the Weld Cast or VAR process actually produces the stock. The Weld Cast or VAR process will produce a metallurgically superior part, free from internal stress, with good surface finish and no length limitations.

Several companies offer VAR equipment that can be customized for specialty processes and shapes. Material surface finishes resulting from the VAR process are smooth and seamless. Another advantage of the VAR process is the rate of material deposition.

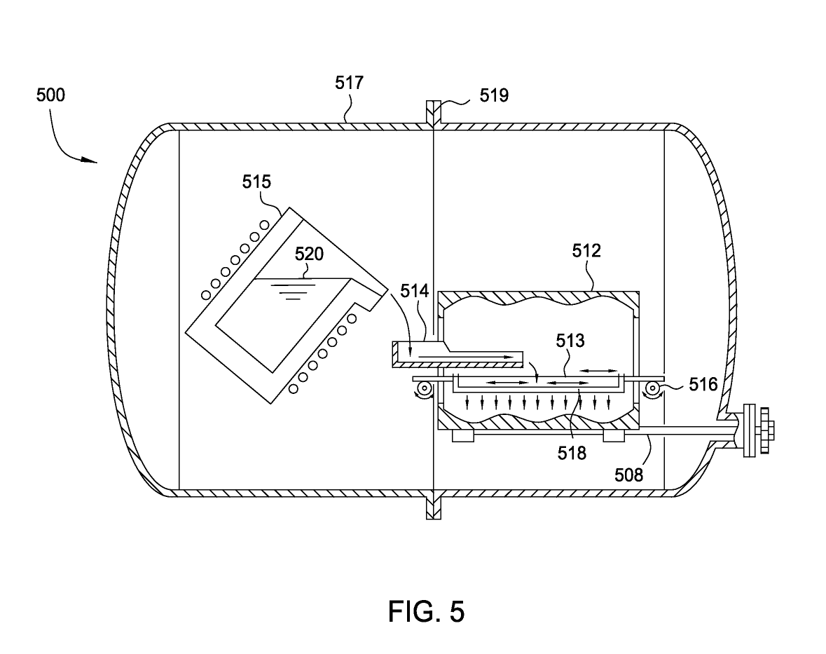

FIG. 5 is a longitudinal sectional view of a centrifugal casting (CC) apparatus 500 employing a CC process to form a rotor. A crucible 515 and a mold 512, having a substantially helical-hypocycloid inner profile formed on an inner surface thereof, are disposed within a chamber 517 assembled through coupling by means of a flange 519. A molten material 520 melted in the crucible 515 is led to the tundish 513 by means of a sprue runner 514. The molten material 520 in the tundish 513 is discharged through a number of hole portions 518 formed in the tundish 513 to thereby be deposited on the inner wall surface of the rotating mold 512. The rotation of the mold 512 is driven by mold drive mechanism 508. A tundish reciprocation mechanism 516 causes the tundish 513 to repeat reciprocation.

The crucible 515 is adapted to melt a metal or an alloy into a liquid material through application of heat, thereby yielding the molten material 520. Examples of melting processes include resistance heating, induction heating, arc melting, and plasma arc melting. Melting and casting are performed in, for example, the atmosphere, vacuum, or an inert gas. The mold 512 may be made of steel protected with a refractory mold wash, green-sand lining, dry-sand lining, or graphite.

The mold 512 is set in rotation during pouring and the molten material 520 is pressed against the profiled inner surface by the centrifugal force under sufficient pressure to substantially evenly fill the profiled inner surface of the mold 512. Solidification of the molten material 520 progresses from the outer surface inward; thus, porosity is greatly reduced and, since inclusions tend to have a lower density, they segregate toward the center which is of little consequence because the inner surface will require post-molding clean-up by machining. Forced movement by shearing the molten material 520 results in grain refinement. Long and large rotors of very uniform quality and wall thickness may be cast. Surface quality is good on the outside of the rotor.

Alternatively, the methods described above with reference to FIGS. 2, 3, and 5 could be used to form other parts having other cross-sectional shapes, such as circular, elliptical, oval, and polygon shapes.

While the foregoing is directed to embodiments of the present invention, other and further embodiments of the invention may be devised without departing from the basic scope thereof, and the scope thereof is determined by the claims that follow.

1. A method for manufacturing a rotor or stator for use in a mud motor, comprising:
rotating a mold having a substantially helical-hypocycloid profile formed on an inner surface thereof; and
pouring molten metal or alloy into the mold, wherein centrifugal force caused by the rotation of the mold presses the molten metal or alloy under sufficient pressure so that the molten metal or alloy substantially evenly fills the profiled inner surface.

2. The method of claim 1, wherein the mold is in a pressure chamber.

3. The method of claim 2, further comprising melting the metal or alloy in a crucible disposed in the pressure chamber

4. The method of claim 3, wherein a vacuum or inert gas atmosphere is maintained in the pressure chamber during rotation, pouring, and melting.

5. The method of claim 3, wherein the metal or alloy is melted by one of: resistance heating, induction heating, arc melting, and plasma arc melting.

6. The method of claim 1, wherein the mold is made of steel protected by: a refractory mold wash, green-sand lining, dry-sand lining, or graphite

7. The method of claim 1, wherein a longitudinal centerline of the mold is substantially horizontal.

8. The method of claim 1, further comprising machining an inner surface of the molded metal or alloy after solidification thereof.

9. The method of claim 1, wherein:
the molten metal or alloy is poured through a tundish, and
the method further comprises reciprocating the tundish while pouring.

10. A rotor manufactured according to the method of claim 1.

11. A stator manufactured according to the method of claim 1.

12. A centrifugal casting apparatus, comprising:
a pressure chamber;
a mold disposed in the pressure chamber having a substantially helical-hypocycloid profile formed on an inner surface thereof;
a first drive mechanism for rotating the mold;
a crucible disposed in the pressure chamber;
a heating element for melting a metal or alloy contained in the crucible;
a sprue runner for transporting molten metal or alloy from the crucible to a tundish;
the tundish having holes formed therethrough for discharging the molten metal or alloy into the mold; and
a second drive mechanism for reciprocating the tundish.
